(19) United States
(12) Patent Application Publication
(10) Pub. No.: US 2026/0075451 A1
(43) Pub. Date: Mar. 12, 2026

(54) DELAY DEPENDENT UPLINK RESOURCE SELECTION

(71) Applicant: QUALCOMM Incorporated, San Diego, CA (US)

(72) Inventors: Diana MAAMARI, San Diego, CA (US); Jing SUN, San Diego, CA (US); Mickael MONDET, Louannec (FR); Gabi SARKIS, San Diego, CA (US); Linhai HE, San Diego, CA (US); Raviteja PATCHAVA, San Diego, CA (US); Prashanth Haridas HANDE, San Diego, CA (US); Jing JIANG, San Diego, CA (US)

(21) Appl. No.: 18/830,228

(22) Filed: Sep. 10, 2024

(51) Int. Cl. H04W 24/10; H04W 72/21

(52) U.S. Cl. CPC H04W 24/10; H04W 72/21

(57) ABSTRACT

Methods, systems, and devices for wireless communications are described. The network may configure a contention-based resource pool for user equipments (UEs) to transmit uplink data with reduced signaling overhead. A UE may select to transmit an uplink message in a configured contention-based resource of the contention-based resource pool without receiving an uplink grant for the contention-based resource. Some uplink traffic types may have stricter delay budgets than other types of uplink traffic. A UE may select an uplink contention-based resource from a contention-based resource pool based on the delay status of an uplink data packet. The UE may determine a probability of accessing the uplink contention-based resource based on the remaining delay budget of the uplink packet. For example, the network may configure a function for the UE to determine the probability of accessing an uplink contention-based resource based on the delay status of a given uplink packet.

### TECHNICAL FIELD

The following relates to wireless communications, including delay dependent uplink resource selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first configuration information for a contention-based uplink resource pool, receiving second configuration information for uplink packet delay status reporting, transmitting a delay status report that indicates a delay status associated with a data packet in accordance with the second configuration information, and transmitting an uplink message including the data packet via a contention-based uplink resource of the contention-based uplink resource pool based on a probability to access the contention-based uplink resource satisfying a probability threshold, where the probability to access the contention-based uplink resource is based on the delay status.

A UE for wireless communications is described. The UE may include one or more memories storing processor executable code, and one or more processors coupled with the one or more memories. The one or more processors may individually or collectively be operable to execute the code to cause the UE to receive first configuration information for a contention-based uplink resource pool, receive second configuration information for uplink packet delay status reporting, transmit a delay status report that indicates a delay status associated with a data packet in accordance with the second configuration information, and transmit an uplink message including the data packet via a contention-based uplink resource of the contention-based uplink resource pool based on a probability to access the contention-based uplink resource satisfying a probability threshold, where the probability to access the contention-based uplink resource is based on the delay status.

Another UE for wireless communications is described. The UE may include means for receiving first configuration information for a contention-based uplink resource pool, means for receiving second configuration information for uplink packet delay status reporting, means for transmitting a delay status report that indicates a delay status associated with a data packet in accordance with the second configuration information, and means for transmitting an uplink message including the data packet via a contention-based uplink resource of the contention-based uplink resource pool based on a probability to access the contention-based uplink resource satisfying a probability threshold, where the probability to access the contention-based uplink resource is based on the delay status.

A non-transitory computer-readable medium storing code for wireless communications is described. The code may include instructions executable by one or more processors to receive first configuration information for a contention-based uplink resource pool, receive second configuration information for uplink packet delay status reporting, transmit a delay status report that indicates a delay status associated with a data packet in accordance with the second configuration information, and transmit an uplink message including the data packet via a contention-based uplink resource of the contention-based uplink resource pool based on a probability to access the contention-based uplink resource satisfying a probability threshold, where the probability to access the contention-based uplink resource is based on the delay status.

Some examples of the method, UEs, and non-transitory computer-readable medium described herein may further include operations, features, means, or instructions for receiving an indication of a configuration associated with calculation of the probability, where the configuration includes an uplink delay-status based function, and where the probability may be based on the configuration.

In some examples of the method, UEs, and non-transitory computer-readable medium described herein, the configuration further includes a priority-based function and the probability may be further based on a priority of the data packet.

In some examples of the method, UEs, and non-transitory computer-readable medium described herein, the configuration further includes a buffer status-based function and the probability may be further based on an amount of buffered data for uplink transmission at the UE in association with the buffer status-based function, the amount of buffered data including the data packet.

Some examples of the method, UEs, and non-transitory computer-readable medium described herein may further include operations, features, means, or instructions for receiving, in response to the uplink message, a back off indication that indicates to refrain from transmitting a second uplink message including the data packet for a period of time after reception of the back off indication and transmitting the second uplink message including the data packet via a second contention-based uplink resource of the contention-based uplink resource pool during the period of time based on the delay status associated with the data packet satisfying a delay threshold.

In some examples of the method, UEs, and non-transitory computer-readable medium described herein, transmitting the delay status report may include operations, features, means, or instructions for transmitting the delay status report based on a remaining delay budget associated with the data packet being below a threshold, where the second configuration information includes the threshold.

Some examples of the method, UEs, and non-transitory computer-readable medium described herein may further include operations, features, means, or instructions for receiving, in response to the uplink message, a back off indication that indicates to refrain from transmitting a second uplink message including the data packet for a period of time after reception of the back off indication, where the period of time may be based on the delay status.

In some examples of the method, UEs, and non-transitory computer-readable medium described herein, the period of time may be based on a priority of the data packet.

Some examples of the method, UEs, and non-transitory computer-readable medium described herein may further include operations, features, means, or instructions for transmitting a buffer status report that indicates an amount of buffered data for uplink transmission at the UE, where the period of time may be based on the amount of buffered data.

Some examples of the method, UEs, and non-transitory computer-readable medium described herein may further include operations, features, means, or instructions for receiving, in response to the uplink message, a back off indication that indicates to refrain from transmitting a second uplink message including the data packet for a period of time after reception of the back off indication and transmitting the second uplink message including the data packet via a second contention-based uplink resource of the contention-based uplink resource pool after a second period of time after the reception of the back off indication, where the second period of time may be scaled in accordance with a scaling factor with respect to the period of time based on the delay status.

In some examples of the method, UEs, and non-transitory computer-readable medium described herein, transmission of the second uplink message after the second period of time may be based on transmission of the delay status report.

Some examples of the method, UEs, and non-transitory computer-readable medium described herein may further include operations, features, means, or instructions for receiving an indication of a prohibit timer associated with frequency of scaling the period of time and starting the prohibit timer based on transmission of the second uplink message.

Some examples of the method, UEs, and non-transitory computer-readable medium described herein may further include operations, features, means, or instructions for receiving an indication of at least one of the scaling factor or a scaling factor range that includes the scaling factor.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports delay dependent uplink resource selection in accordance with one or more aspects of the present disclosure.

FIG. 2 shows an example of a contention-based resource pool that supports delay dependent uplink resource selection in accordance with one or more aspects of the present disclosure.

FIG. 3 shows an example of a wireless communications system that supports delay dependent uplink resource selection in accordance with one or more aspects of the present disclosure.

FIG. 4 shows an example of a process flow that supports delay dependent uplink resource selection in accordance with one or more aspects of the present disclosure.

FIGS. 5 and 6 show block diagrams of devices that support delay dependent uplink resource selection in accordance with one or more aspects of the present disclosure.

FIG. 7 shows a block diagram of a communications manager that supports delay dependent uplink resource selection in accordance with one or more aspects of the present disclosure.

FIG. 8 shows a diagram of a system including a device that supports delay dependent uplink resource selection in accordance with one or more aspects of the present disclosure.

FIGS. 9 through 10 show flowcharts illustrating methods that support delay dependent uplink resource selection in accordance with one or more aspects of the present disclosure.

### DETAILED DESCRIPTION

In wireless communications systems, a large quantity of user equipments (UEs) may camp on a cell in the radio resource control (RRC) connected mode or the RRC idle mode. The network may configure a contention-based resource pool for such UEs to transmit uplink data with reduced signaling overhead. The contention-based resource pool may reduce signaling overhead via allowing for reduction of random access channel messages, scheduling requests (SRs), buffer status reports (BSRs), and uplink grants. For example, a UE may select to transmit an uplink message in a contention-based resource of the configured contention-based resource pool without transmitting an SR and/or without receiving an uplink grant for the contention-based resource. Multiple UEs may attempt to transmit in the same contention-based resource, which may result in a collision. In the event of a collision, the network may transmit a back off indication to the UE which may indicate a period of time for the UE to wait prior to re-attempting transmission. Some uplink traffic types, such as extended reality (XR), however, may have stricter delay budgets than other types of uplink traffic.

Aspects of this disclosure relate to selection by a UE of an uplink contention-based resource from a contention-based resource pool based on the delay status of an uplink data packet. For example, the UE may determine a probability of accessing the uplink contention-based resource based on the remaining delay budget (RDB) of the uplink packet. For example, the network may configure a function for the UE to determine the probability of accessing an uplink contention-based resource based on the delay status of a given uplink packet. For example, if the RDB is less than a configured threshold, the UE may determine to access a contention-based resource. In some examples, the UE may further determine the probability of accessing the uplink contention-based resource based on a buffer status (e.g., an amount of buffered data the UE has for transmission) and/or a priority level of the packet the UE has for transmission. In some examples, the UE may transmit a delay status report to the network, for example, based on the RDB being less than a configured threshold. In some examples, the network may determine a back off period based on the delay status (e.g., the network may indicate a shorter back off period for packets with a lower RDB). In some examples, the UE may autonomously scale the back off period indicated by the network based on the RDB. For example, the UE may autonomously reduce the indicated back off period if the RDB is below a threshold.

Aspects of the disclosure are initially described in the context of wireless communications systems. Aspects of the disclosure are further illustrated by and described with reference to examples of contention-based resource pools, process flows, apparatus diagrams, system diagrams, and flowcharts that relate to delay dependent uplink resource selection.

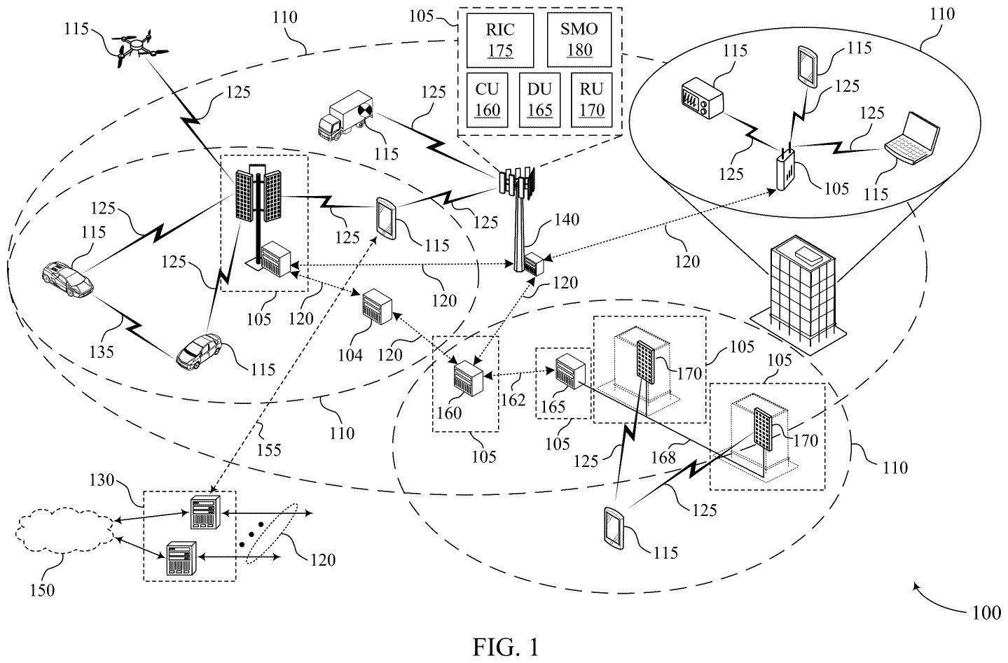

FIG. 1 shows an example of a wireless communications system 100 that supports delay dependent uplink resource selection in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies including future systems and radio technologies, not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support delay dependent uplink resource selection as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, UEs 115 may perform a random access channel (RACH) procedure to access a cell. For example, UEs 115 may select a RACH resource and may transmit a first RACH message (e.g., a msg1) to a network entity 105 via the RACH resource. For example, RACH resources may be mapped to synchronization signal blocks (SSBs) transmitted by a network entity 105, and the UEs 115 may select RACH resources based on measurements of the SSBs. If multiple UEs 115 transmit msg1s via the same RACH resource, the network entity 105 may transmit a back off indication to one or more of the multiple UEs, for example, via a msg2. For example, the back off indicator field in msg2 may identify the overload condition in the cell. The back off indicator field in msg2 may include four bits to represent sixteen possible indices. Table 1 shows index values and back off time values. For example, if a UE 115 receives a back off indication in the msg2 from a network entity 105, the UE may wait for the indicated period of time before attempting to transmit another msg1 to the network entity 105.

TABLE 1

| Index | Back Off Parameter Value (ms) |
|---|---|
| 0 | 5 |
| 1 | 10 |
| 2 | 20 |
| 3 | 30 |
| 4 | 40 |
| 5 | 60 |
| 6 | 80 |
| 7 | 120 |
| 8 | 160 |
| 9 | 240 |
| 10 | 320 |
| 11 | 480 |
| 12 | 960 |
| 13 | 1920 |
| 14 | Reserved |
| 15 | Reserved |

The back off value may be scaled by a scaling factor. For example, if the random access response (e.g., the msg2) includes a MAC sub packet data unit (PDU) with the back off indicator, the UE 115 may set the back off value to the value of the back off indicator multiplied by the scaling factor. For example, the scaling factor may be indicated via an RRC parameter (e.g., via an RA-Prioritization RRC information element).

Given the large coverage and narrow band nature of FDD low band carriers, a large quantity of UEs 115 (e.g., both mobile broadband (MBB) UEs 115 and IoT UEs 115) may camp on a carrier or cell. For example, the UEs 115 may camp on a carrier or cell in the RRC connected mode or the RRC idle mode. While camped on a cell, the UEs 115 may have uplink traffic for transmission to the cell (e.g., to the network entity 105 associated with the cell) with low duty cycle and small packet sizes. The network entity 105 may configure a contention-based resource pool for such UEs 115 to transmit uplink data that allows for reduced signaling overhead via reduction of physical random access channel (PRACH) messages, SRs, BSRs, uplink grants, and/or channel state information (CSI) reference signals (CSI-RSs). Transmission over such contention-based resources of a contention-based resource pool may be referred to as connectionless uplink transmission via a resource pool. Connectionless uplink transmission via a resource pool may be similar to 2-step RACH procedures and/or small data transmissions (SDTs). The design of connectionless uplink transmissions may account for transmitter and receiver complexity (e.g., IoT devices may have less complex transmitters and receivers than other UEs 115).

As described herein, a UE 115 may select to transmit an uplink message in a configured contention-based resource of the contention-based resource pool without transmitting an SR and/or without receiving an uplink grant for the contention-based resource. Multiple UEs 115 may attempt to transmit in the same contention-based resource, which may result in a collision. In the event of a collision, the network entity 105 may transmit a back off indication to the UE 115 which may indicate a period of time for the UE 115 to wait prior to re-attempting transmission.

In some examples, additional UE back off mechanisms based on the resource allocation may be used to reduce collisions in a resource pool (e.g., a heterogeneous resource pool such as the contention-based resource pool). For example, back off may be based on the modulation and coding scheme (MCS). For example, if the network entity 105 detects a congestion with a given MCS, the network entity 105 may increase the back off range for UEs 115 that use the given MCS to avoid collisions. As another example, the back off may be based on the allocation size. For example, if the allocation size is higher for a particular UE 115, the UE 115 may use a lower back off value as there may be a lower chance of collision. As another example, the back off may be based on payload domain. For example, as the resource pool gets busier, the network entity 105 may allocate a higher back off for the UEs 115 with a higher payload, which may allow the UEs 115 with a low payload to transmit first, followed by the UEs 115 with a higher payload. In such cases, the network entity 105 may also restrict the UE 115 to transmit a given amount of data in each resource pool occasion/resource. As another example, the back off may be based on the quantity of layers in a multi-user (MU) MIMO transmission. For example, there may be a different back off based on the quantity of layers if the UEs 115 are transmitting in resources allocated for MU-MIMO (e.g., users transmitting in a high quantity of layers may have a higher back off as compared to users with a lower quantity of layers). The network entity 105 may also restrict users (e.g., UEs 115) to transmit within a maximum quantity of layers. In some examples, UEs 115 may apply a back off based on the combination of MCS, the quantity of layers, allocation size, or payload size. The network entity 105 may indicate the back off probability to users (e.g., to UEs 115) dynamically via a group common (GC) physical downlink control channel (PDCCH).

In some examples, the network entity 105 may configure UEs 115 to transmit delay status reports (DSRs). For example, a DSR may be used to provide the serving network entity 105 with the delay status of a logical channel group (LCG) of the UE 115. Without a DSR, the network entity 105 may not be informed of the uplink experienced delay at a UE 115, and the difference between the uplink experienced delay at the UE 115 and the nominal packet delay budget (PDB) for the packet(s) associated with a given LCG. The delay for an LCG may include the remaining time, which may be the smallest remaining value of the Packet Data Convergence Protocol (PDCP) discard timers associated with the LCG. RRC may control the DSR procedure by configuring a remaining time threshold, which may be the threshold remaining time for triggering a DSR for a particular LCG. A DSR may be triggered if the smallest remaining value of the PDCP discard timers among all the data buffered for the LCG that has not been transmitted in any MAC PDU becomes below the remaining time threshold (e.g., configured by RRC) of the LCG.

For example, for XR applications with low latency demands, transmitting the uplink data with minimum overhead may be beneficial (e.g., overhead may involve latency incurred from the UE 115 transmitting SRs/BSRs and then receiving an uplink grant to transmit a physical uplink shared channel carrying the uplink data). Configured grants (CGs) may be used to carry some XR uplink traffic flows. Some XR uplink traffic, however, may have unpredictable arrival, such as, “hand-tracking.” Such XR uplink traffic with unpredictable arrival may have non-periodic packet arrivals and may be event-based. Accordingly, contention-based resources may be used for transmission of XR uplink traffic (e.g., to avoid latency associated with transmitting SRs/BSRs and to account for unpredictable traffic arrival). As described herein, XR may have stricter delay budgets than other types of uplink traffic that may use the contention-based resources (e.g., such as enhanced MBB (cMBB) or IoT) as XR uplink data applications may have tight delay demands.

Aspects of this disclosure relate to selection by a UE 115 of an uplink contention-based resource from a contention-based resource pool based on the delay status of an uplink data packet. Accordingly, UEs 115 that can access a contention-based resource pool and with RDBs that are about to expire may be prioritized (e.g., in order to meet the nominal PDBs). For example, the UE 115 may determine a probability of accessing the uplink contention-based resource based on the RDB of the uplink packet. For example, the network entity 105 may configure a function for the UE 115 to determine the probability of accessing an uplink contention-based resource based on the delay status of a given uplink packet. For example, if the RDB is less than a configured threshold, the UE 115 may determine to access a contention-based resource. In some aspects, the back off applied may be delay dependent. For example, if the network entity 105 detects congestion and is not able to detect the users, a UE 115 may apply delay dependent back off (e.g., may reduce the back off for high priority uplink traffic).

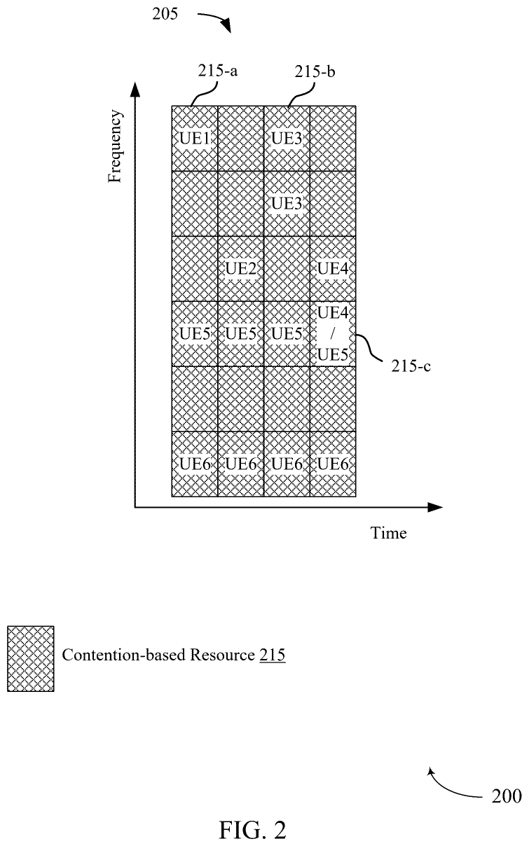

FIG. 2 shows an example 200 of a contention-based resource pool 205 that supports delay dependent uplink resource selection in accordance with one or more aspects of the present disclosure. The example 200 of the contention-based resource pool 205 may implement or may be implemented by aspects of the wireless communications system 100.

For example, a network entity 105 may configure the contention-based resource pool 205 for one or more UEs 115 camped on the network entity 105. For example, the network entity 105 may transmit configuration information that indicates the resources 215 (e.g., the time and frequency resources) of the contention-based resource pool 205. The resources 215 of the contention-based resource pool 205 may be used for uplink small packet transmission without explicit uplink grants.

Transmissions in resources 215 of the contention-based resource pool 205 may be contention-based. The contention-based resource pool 205 may be used for a mix of different payload sized (e.g., different applications) and MCSs. For example, a first UE 115 (shown as UE1) may transmit a first packet having a first payload size and using a first MCS in the resource 215-a and a different UE 115 (shown as UE3) may transmit a second packet having a second payload size and using a second MCS in the resource 215-b. There is a chance of collision in the resources 215 of the contention-based resource pool 205. For example, a fourth UE 115 (shown as UE4) and a fifth UE 115 (shown as UE5) may both attempt to transmit in the resource 215-c.

In some examples, for large size cells, UEs 115 may acquire timing synchronization with the cell (e.g., based on monitoring for synchronization signals such as primary synchronization signals (PSSs) and secondary synchronization signals (SSSs) transmitted by the cell) before transmitting in a resource 215.

The network entity 105 may perform blind decoding in the resources 215. In some examples, the network entity 105 may configure the resource pool based on both traffic demands and the processing capability of the network entity 105. For reliable delivery of packets, the network entity 105 may implement acknowledgment feedback and UEs 115 may perform retransmission based on negative acknowledgement feedback and/or absence of acknowledgment feedback for a transmission.

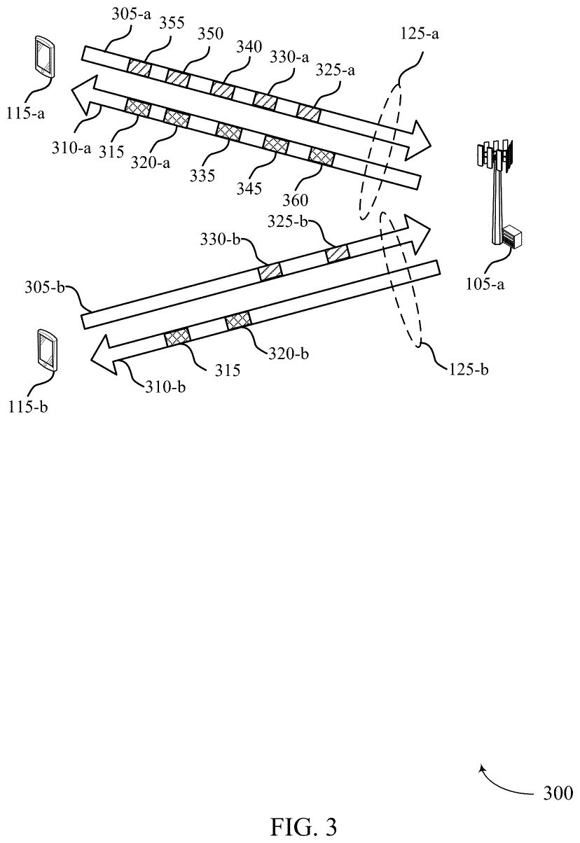

FIG. 3 shows an example of a wireless communications system 300 that supports delay dependent uplink resource selection in accordance with one or more aspects of the present disclosure. The wireless communications system 300 may implement or may be implemented by aspects of the wireless communications system 100. For example, the wireless communications system 300 includes a UE 115-a, a UE 115-b, and a network entity 105-a, which may be examples of a UE 115 and a network entity 105 described with respect to FIG. 1.

The network entity 105-a may communicate with the UE 115-a via a communication link 125-a, which may be an example of an NR or LTE link between the UE 115-a and the network entity 105-a. The network entity 105-a may communicate with the UE 115-b via a communication link 125-b, which may be an example of an NR or LTE link between the UE 115-b and the network entity 105-a. In some cases, the communication link 125-a and the communication link 125-b may include examples of an access link (e.g., a Uu link). The communication link 125-a and the communication link 125-b may each include a bi-directional link that enables both uplink and downlink communication. For example, the UE 115-a may transmit uplink signals 305-a, such as uplink control signals or uplink data signals, to the network entity 105-a using the communication link 125-a, and the network entity 105-a may transmit downlink signals 310-a, such as downlink control signals or downlink data signals, to the UE 115-a using the communication link 125-a. The UE 115-b may transmit uplink signals 305-b, such as uplink control signals or uplink data signals, to the network entity 105-a using the communication link 125-b, and the network entity 105-a may transmit downlink signals 310-b, such as downlink control signals or downlink data signals, to the UE 115-b using the communication link 125-b.

The network entity 105-a may transmit first configuration information 315 (e.g., via system information, RRC, or a GC-PDCCH) that configures a contention-based resource pool (e.g., a contention-based resource pool 205 as described herein). In some examples, the network entity 105-a may transmit second configuration information 320-a to the UE 115-a (e.g., via system information, RRC, a MAC control element (MAC-CE), or a PDCCH) for delay status reporting for the UE 115-a and/or the network entity 105-a may transmit second configuration information 320-b to the UE 115-b for delay status reporting for the UE 115-b.

The UE 115-a may transmit a delay status report 325-a for an uplink packet (e.g., based on a RDB for the uplink packet being less than a threshold configured in the second configuration information 320-a). The UE 115-b may transmit a delay status report 325-b for an uplink packet (e.g., based on a RDB for the uplink packet being less than a threshold configured in the second configuration information 320-b).

The UE 115-a may transmit an uplink message 330-a that includes the uplink packet via a contention-based uplink resource of the contention-based uplink resource pool based on a probability to access the contention-based uplink resource satisfying a probability threshold. The probability to access the contention-based uplink resource may be based on the delay status. For example, the UE 115-a may determine to access a particular contention-based uplink resource of the contention-based uplink resource pool if the probability to successfully access the contention-based uplink resource, p, is greater than a threshold probability, n. The probability to access the contention-based uplink resource, p, may be adjusted or adapted dynamically to consider the uplink experienced delay to allow for prioritization of the resource pool acquisition based on the experienced delay budget. In some examples, the network entity 105-a may indicate, for example, in the first configuration information 315, a function for determining the probability to access a resource of the contention-based resource pool based on the uplink experienced delay (e.g., the RDB). For example, if the RDB of an uplink packet drops below a configurable threshold (e.g., which may be RRC configured) for an LCG, the uplink packet may be eligible for a higher probability of access. The function configured by the network entity 105-a may be linear, exponential, or quadratic. In some examples, the function may also consider the MCS, the quantity of layers, the allocation size, and/or the payload size.

In some examples, a 6th Generation equivalent of the 5G quality of service identifier (5QI) may have a mapping to a specific probability, p. For example, for higher priority traffic, the probability to access, p, may be higher. There may be multiple configurable p values that may be configured as part of the quality of service (QoS) indicator. For example, the probability for XR users, p_XR, may be higher than the probability for cMBB users, p_eMBB, and the probability for IoT users, p_IoT.

In some examples, a collision may occur in the contention-based uplink resource that the UE 115-a may transmit the uplink message. For example, the UE 115-b also may transmit an uplink message 330-b in the same contention-based resource as the uplink message 330-a. In such examples, the network entity 105-a may transmit a back off indication 335 to the UE 115-a. In some examples, the network entity 105-a may account for the delays reported in the delay status report 325-a and the delay status report 325-b when determining the back off value indicated in the back off indication 335. In some examples, for a delay critical uplink packet, the UE 115-a may ignore the back off indication 335. For example, the back off indication 335 may indicate a period of time for the UE 115-a to wait before attempting to retransmit the uplink packet. If the uplink packet is delay critical, the UE 115-a may transmit a second uplink message 340 via another contention-based uplink resource of the contention-based uplink resource pool during the period of time (e.g., the UE 115-a may ignore the back off indication).

In some examples, the network entity 105-a may transmit an indication 345 of a scaling factor for the UE 115-a to apply to the back off value in the back off indication 335. In some examples, the back off value indicated in the back off indication 335 and/or the scaling factor may be adjusted and/or dynamically adapted (e.g., by the network entity 105-a or autonomously by the UE 115-a) in consideration of the uplink experienced delay (e.g., based on the delay status report 325-a). Adjusting and/or dynamically adapting the back off value or the scaling factor may allow for prioritization of resource pool acquisition based on the experienced delay budget of the UE 115-a. In some examples, if the remaining time of a PDU drops below a configurable threshold for the logical channel associated with the PDU, the PDU may be eligible for a lower back off value or a lower scaling factor. As another example, the scaling factor or the product of the back off value and the scaling factor may be zero to allow for immediate access to the contention-based resource pool. In some examples, multiple remaining time thresholds may be configurable for each logical channel, and any satisfied threshold may trigger an update for the back off value or the scaling factor value. In some examples, the UE 115-a may transmit a report 350 which may indicate the updated back off value or the updated scaling factor value.

In some examples, the network entity 105-a may control the update of the back off value and/or the scaling factor. For example, a function may be defined (e.g., standardized) that may map the RDB to an offset that may be added to the back off value and/or the scaling factor. The function may be linear, exponential, or quadratic. In some examples, the function may also consider the MCS, the quantity of layers, the allocation size, the payload size, and/or the uplink RDB.

In some examples, the back off value, the scaling factor, and/or the probability to access a contention-based resource of the contention-based resource pool may be adjusted and/or dynamically adapted based on both the uplink experienced delay and the buffer status for the logical channel (e.g., the amount of buffered data for uplink transmission associated with the logical channel). In some examples, the back off value, the scaling factor, and/or the probability to access a contention-based resource of the contention-based resource pool also may be adjusted and/or dynamically adapted based on the static priority associated with the logical channel. For example, for some logical channels with a priority p, if the remaining time of a PDU is below a configurable threshold for the associated logical channel, the PDU may be eligible for a lower back off value or a lower scaling factor. In some examples, the configurable remaining time threshold for a logical channel may be configured via RRC. As another example, if the if the remaining time of a PDU is below a configurable threshold for the associated logical channel and if the logical channel has a BSR below a configurable threshold, three PDU may be eligible for a lower back off value or a lower scaling factor. In some examples, the configurable remaining time threshold and/or the configurable BSR threshold for a logical channel may be configured via RRC.

In some examples, the UE 115-a may autonomously update the back off indication value, the scaling factor, or the probability of accessing a contention-based resource of the contention-based resource pool, for example, based on the statistical uplink experienced delay budget. In some examples, the UE 115-a may transmit the report 350 that indicates the updated back off indication value, the scaling factor, or the probability of accessing a contention-based resource of the contention-based resource pool. In some examples, the UE 115-a may transmit in the report 350 a recommended update to the back off indication value, the scaling factor, or the probability of accessing a contention-based resource of the contention-based resource pool, and the back off value in the back off indication 335 or the scaling factor in the indication 345 may be based on the recommended update in the report 350. In some examples, the UE 115-a may be allowed to autonomously update the back off indication value, the scaling factor, or the probability of accessing a contention-based resource of the contention-based resource pool after transmission of a BSR 355 to the network entity 105-a.

In some examples, the network entity 105-a may prohibit the UE 115-a from updating the back off value or the scaling factor too frequently. For example, the UE 115-a may be configured, for example, via control signaling 360, with a prohibit timer to disallow updating the back off value or the scaling factor while the prohibit timer is running. For example, the UE 115-a may start the prohibit timer for a particular logical channel after autonomously updating the back off value or the scaling factor for the logical channel. In some examples, the control signaling may indicate a range for the back off indication and/or the scaling factor. For example, the UE 115-a may autonomously update the back off value and/or the scaling factor within the indicated range. For example, the minimum and maximum back off value and/or scaling factor may be RRC configured (e.g., the control signaling 360 may be RRC signaling).

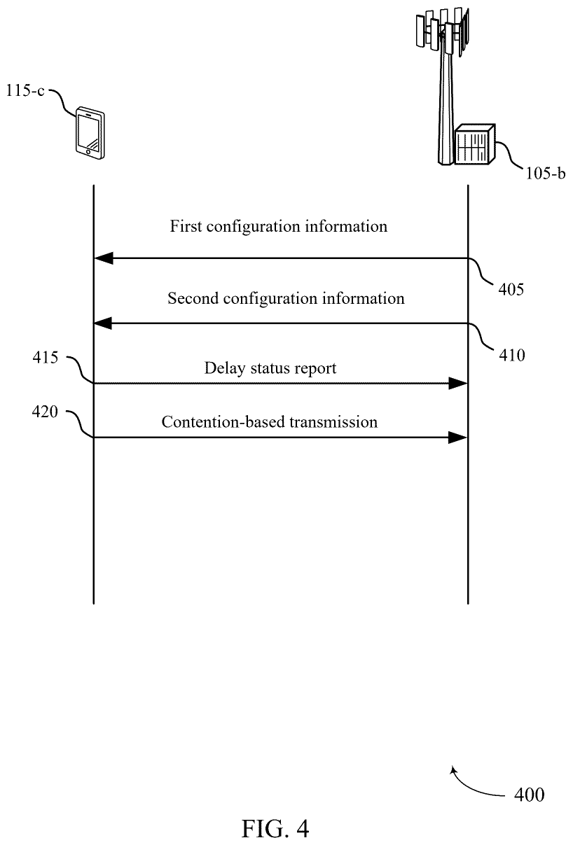

FIG. 4 shows an example of a process flow 400 that supports delay dependent uplink resource selection in accordance with one or more aspects of the present disclosure. The process flow 400 may include a UE 115-c and a network entity 105-b, which may be examples of a UE 115 and a network entity 105 as described herein. In the following description of the process flow 400, the communications between the network entity 105-b and the UE 115-c may be transmitted in a different order than the example order shown, or the operations performed by the network entity 105-b and the UE 115-c may be performed in different orders or at different times. Some operations may also be omitted from the process flow 400, and other operations may be added to the process flow 400.

At 405, the UE 115-c may receive, from the network entity 105-b, first configuration information for a contention-based uplink resource pool.

At 410, the UE 115-c may receive, from the network entity 105-b, second configuration information for uplink packet delay status reporting.

At 415, the UE 115-c may transmit, to the network entity 105-b, a delay status report that indicates a delay status associated with a data packet in accordance with the second configuration information.

At 420, the UE 115-c may transmit, to the network entity 105-b, an uplink message that includes the data packet via a contention-based uplink resource of the contention-based uplink resource pool based on a probability to access the contention-based uplink resource satisfying a probability threshold. The probability to access the contention-based uplink resource may be based on the delay status of the data packet.

In some examples, the UE 115-c may receive, from the network entity 105-b, an indication of a configuration associated with calculation of the probability. For example, the configuration may include an uplink delay-status based function, and the probability may be based on the configuration. In some examples, the configuration may include a priority-based function, and the probability may be based on a priority of the data packet. In some examples, the configuration may include a buffer status-based function, and the probability may be based on an amount of buffered data for uplink transmission at the UE in association with the buffer status-based function, the amount of buffered data including the data packet.

In some examples, the UE 115-c may receive, from the network entity 105-b in response to the uplink message at 420, a back off indication that indicates to refrain from transmitting a second uplink message that includes the data packet for a period of time after reception of the back off indication. In some such examples, the UE 115-c may transmit the second uplink message that includes the data packet via a second contention-based uplink resource of the contention-based uplink resource pool during the period of time based on the delay status associated with the data packet satisfying a delay threshold. For example, the UE 115-c may dynamically adjust the indicated back off based on the delay status of the data packet.

In some examples, at 415, the UE 115-c may transmit the delay status report based on a RDB associated with the data packet being below a threshold, and the second configuration information may indicate the threshold.

In some examples, the UE 115-c may receive, from the network entity 105-b in response to the uplink message at 420, a back off indication that indicates to refrain from transmitting a second uplink message that includes the data packet for a period of time after reception of the back off indication, and the period of time may be based on the delay status. For example, the network entity 105-b may determine the back off value based on the delay status report. In some examples, the period of time (e.g., the back off value) may be based on (e.g., may be determined by the network entity 105-b based on) the priority of the data packet. In some examples, the UE 115-c may transmit a BSR to the network entity 105-b that indicates an amount of buffered data for uplink transmission at the UE 115-c, and the period of time (e.g., the back off value) may be based on (e.g., may be determined by the network entity 105-b based on) the amount of buffered data.

In some examples, the UE 115-c may receive, from the network entity 105-b in response to the uplink message at 420, a back off indication that indicates to refrain from transmitting a second uplink message that includes the data packet for a period of time after reception of the back off indication. In some such examples, the UE 115-c may transmit the second uplink message that includes the data packet via a second contention-based uplink resource of the contention-based uplink resource pool after a second period of time after the reception of the back off indication, and the second period of time may be scaled in accordance with a scaling factor with respect to the period of time based on the delay status. In some examples, transmission of the second uplink message after the second period of time may be based on transmission of the delay status report. In some examples, the UE 115-c may receive, from the network entity 105-b, an indication of a prohibit timer associated with the frequency of scaling the period of time. The UE 115-c may start the prohibit timer based on transmission of the second uplink message. For example, the prohibit timer may prevent the UE 115-b from autonomously scaling the indicated back off until the prohibit timer stops. In some examples, the UE 115-c may receive, from the network entity 105-b, an indication of at least one of the scaling factor or a scaling factor range that includes the scaling factor.

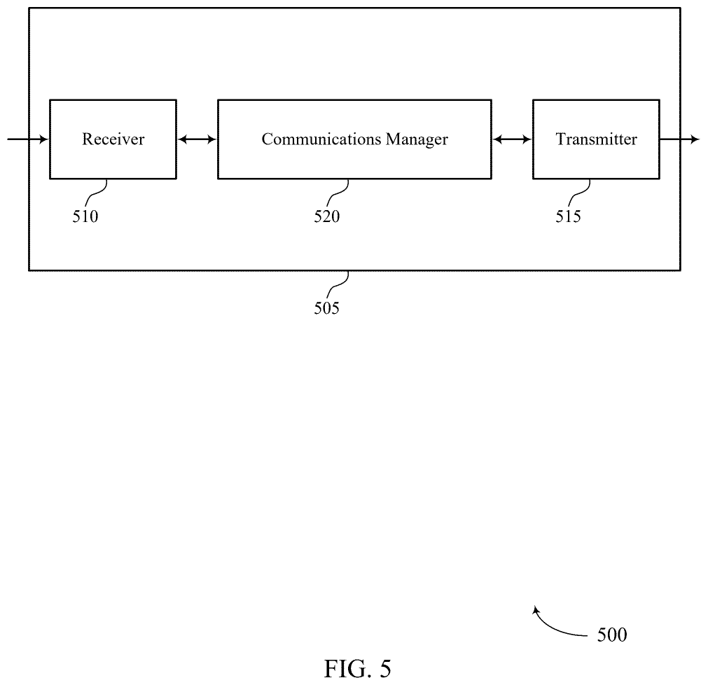

FIG. 5 shows a block diagram 500 of a device 505 that supports delay dependent uplink resource selection in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to delay dependent uplink resource selection). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to delay dependent uplink resource selection). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of delay dependent uplink resource selection as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), a GPU, an NPU, an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, a graphics processing unit (GPU), a neural processing unit, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving first configuration information for a contention-based uplink resource pool. The communications manager 520 is capable of, configured to, or operable to support a means for receiving second configuration information for uplink packet delay status reporting. The communications manager 520 is capable of, configured to, or operable to support a means for transmitting a delay status report that indicates a delay status associated with a data packet in accordance with the second configuration information. The communications manager 520 is capable of, configured to, or operable to support a means for transmitting an uplink message including the data packet via a contention-based uplink resource of the contention-based uplink resource pool based on a probability to access the contention-based uplink resource satisfying a probability threshold, where the probability to access the contention-based uplink resource is based on the delay status.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced latency and more efficient utilization of communication resources.

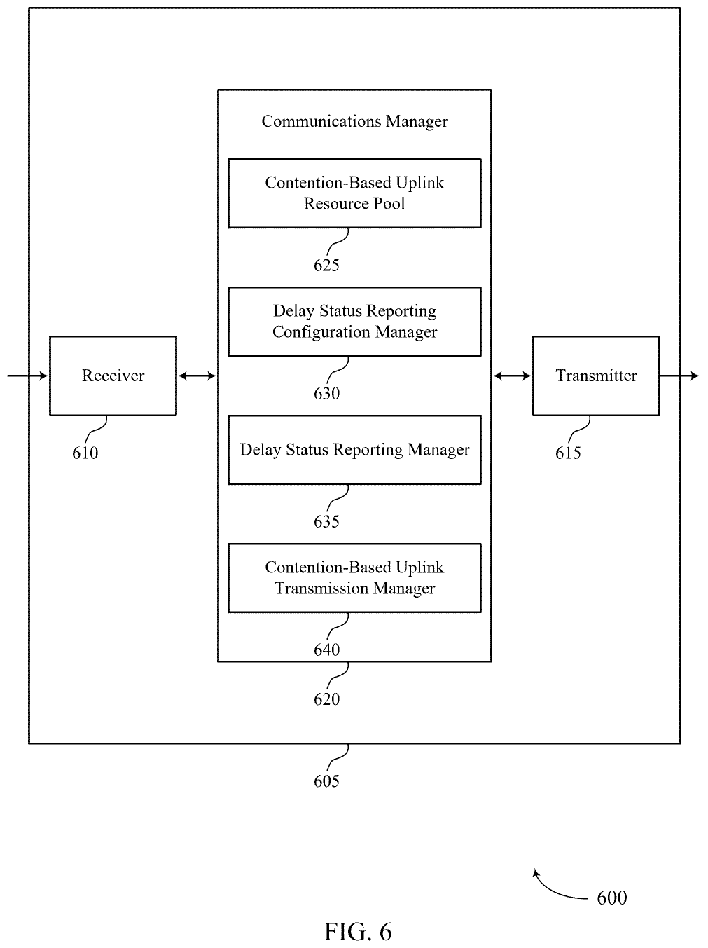

FIG. 6 shows a block diagram 600 of a device 605 that supports delay dependent uplink resource selection in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to delay dependent uplink resource selection). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to delay dependent uplink resource selection). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of delay dependent uplink resource selection as described herein. For example, the communications manager 620 may include a contention-based uplink resource pool 625, a delay status reporting configuration manager 630, a delay status reporting manager 635, a contention-based uplink transmission manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The contention-based uplink resource pool 625 is capable of, configured to, or operable to support a means for receiving first configuration information for a contention-based uplink resource pool. The delay status reporting configuration manager 630 is capable of, configured to, or operable to support a means for receiving second configuration information for uplink packet delay status reporting. The delay status reporting manager 635 is capable of, configured to, or operable to support a means for transmitting a delay status report that indicates a delay status associated with a data packet in accordance with the second configuration information. The contention-based uplink transmission manager 640 is capable of, configured to, or operable to support a means for transmitting an uplink message including the data packet via a contention-based uplink resource of the contention-based uplink resource pool based on a probability to access the contention-based uplink resource satisfying a probability threshold, where the probability to access the contention-based uplink resource is based on the delay status.

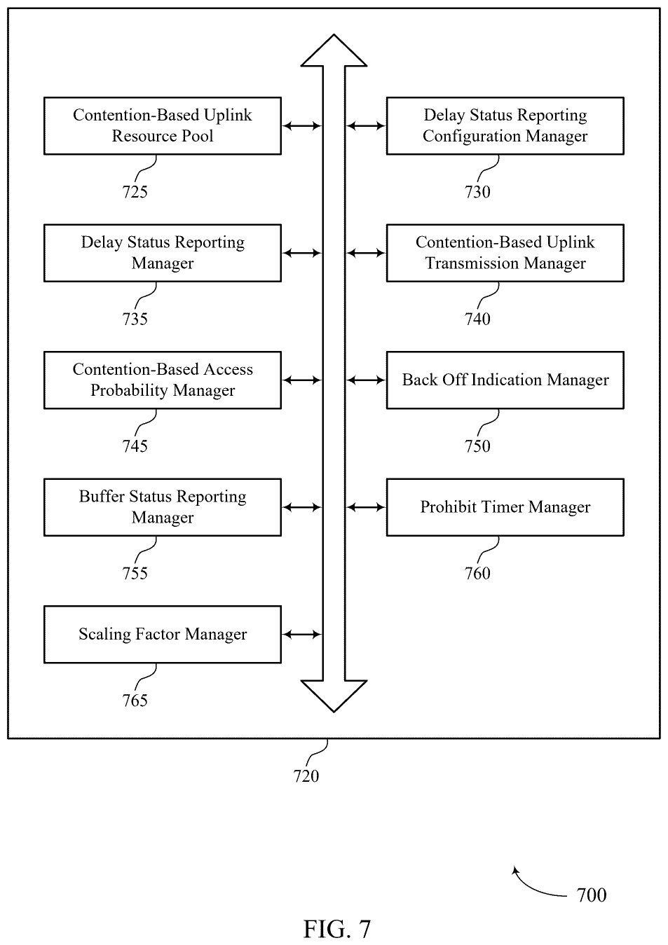

FIG. 7 shows a block diagram 700 of a communications manager 720 that supports delay dependent uplink resource selection in accordance with one or more aspects of the present disclosure. The communications manager 720 may be an example of aspects of a communications manager 520, a communications manager 620, or both, as described herein. The communications manager 720, or various components thereof, may be an example of means for performing various aspects of delay dependent uplink resource selection as described herein. For example, the communications manager 720 may include a contention-based uplink resource pool 725, a delay status reporting configuration manager 730, a delay status reporting manager 735, a contention-based uplink transmission manager 740, a contention-based access probability manager 745, a back off indication manager 750, a buffer status reporting manager 755, a prohibit timer manager 760, a scaling factor manager 765, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The contention-based uplink resource pool 725 is capable of, configured to, or operable to support a means for receiving first configuration information for a contention-based uplink resource pool. The delay status reporting configuration manager 730 is capable of, configured to, or operable to support a means for receiving second configuration information for uplink packet delay status reporting. The delay status reporting manager 735 is capable of, configured to, or operable to support a means for transmitting a delay status report that indicates a delay status associated with a data packet in accordance with the second configuration information. The contention-based uplink transmission manager 740 is capable of, configured to, or operable to support a means for transmitting an uplink message including the data packet via a contention-based uplink resource of the contention-based uplink resource pool based on a probability to access the contention-based uplink resource satisfying a probability threshold, where the probability to access the contention-based uplink resource is based on the delay status.

In some examples, the contention-based access probability manager 745 is capable of, configured to, or operable to support a means for receiving an indication of a configuration associated with calculation of the probability, where the configuration includes an uplink delay-status based function, and where the probability is based on the configuration.

In some examples, the configuration further includes a priority-based function. In some examples, the probability is further based on a priority of the data packet.

In some examples, the configuration further includes a buffer status-based function. In some examples, the probability is further based on an amount of buffered data for uplink transmission at the UE in association with the buffer status-based function, the amount of buffered data including the data packet.

In some examples, the back off indication manager 750 is capable of, configured to, or operable to support a means for receiving, in response to the uplink message, a back off indication that indicates to refrain from transmitting a second uplink message including the data packet for a period of time after reception of the back off indication. In some examples, the contention-based uplink transmission manager 740 is capable of, configured to, or operable to support a means for transmitting the second uplink message including the data packet via a second contention-based uplink resource of the contention-based uplink resource pool during the period of time based on the delay status associated with the data packet satisfying a delay threshold.

In some examples, to support transmitting the delay status report, the delay status reporting manager 735 is capable of, configured to, or operable to support a means for transmitting the delay status report based on a RDB associated with the data packet being below a threshold, where the second configuration information includes the threshold.

In some examples, the back off indication manager 750 is capable of, configured to, or operable to support a means for receiving, in response to the uplink message, a back off indication that indicates to refrain from transmitting a second uplink message including the data packet for a period of time after reception of the back off indication, where the period of time is based on the delay status.

In some examples, the period of time is based on a priority of the data packet.

In some examples, the buffer status reporting manager 755 is capable of, configured to, or operable to support a means for transmitting a buffer status report that indicates an amount of buffered data for uplink transmission at the UE, where the period of time is based on the amount of buffered data.

In some examples, the back off indication manager 750 is capable of, configured to, or operable to support a means for receiving, in response to the uplink message, a back off indication that indicates to refrain from transmitting a second uplink message including the data packet for a period of time after reception of the back off indication. In some examples, the contention-based uplink transmission manager 740 is capable of, configured to, or operable to support a means for transmitting the second uplink message including the data packet via a second contention-based uplink resource of the contention-based uplink resource pool after a second period of time after the reception of the back off indication, where the second period of time is scaled in accordance with a scaling factor with respect to the period of time based on the delay status.

In some examples, transmission of the second uplink message after the second period of time is based on transmission of the delay status report.

In some examples, the prohibit timer manager 760 is capable of, configured to, or operable to support a means for receiving an indication of a prohibit timer associated with frequency of scaling the period of time. In some examples, the prohibit timer manager 760 is capable of, configured to, or operable to support a means for starting the prohibit timer based on transmission of the second uplink message.

In some examples, the scaling factor manager 765 is capable of, configured to, or operable to support a means for receiving an indication of at least one of the scaling factor or a scaling factor range that includes the scaling factor.

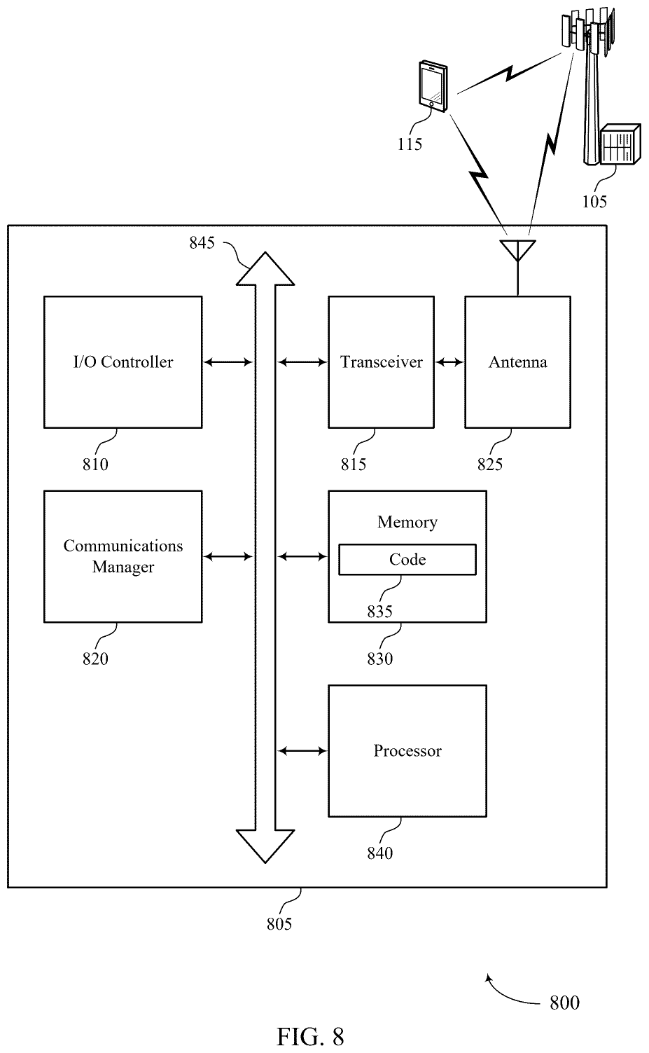

FIG. 8 shows a diagram of a system 800 including a device 805 that supports delay dependent uplink resource selection in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more GPUs, one or NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting delay dependent uplink resource selection). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving first configuration information for a contention-based uplink resource pool. The communications manager 820 is capable of, configured to, or operable to support a means for receiving second configuration information for uplink packet delay status reporting. The communications manager 820 is capable of, configured to, or operable to support a means for transmitting a delay status report that indicates a delay status associated with a data packet in accordance with the second configuration information. The communications manager 820 is capable of, configured to, or operable to support a means for transmitting an uplink message including the data packet via a contention-based uplink resource of the contention-based uplink resource pool based on a probability to access the contention-based uplink resource satisfying a probability threshold, where the probability to access the contention-based uplink resource is based on the delay status.

By including or configuring the communications manager 820 in accordance with examples as described herein, the device 805 may support techniques for reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of delay dependent uplink resource selection as described herein, or the at least one processor 840 and the at least one memory 830 may be otherwise configured to, individually or collectively, perform or support such operations.

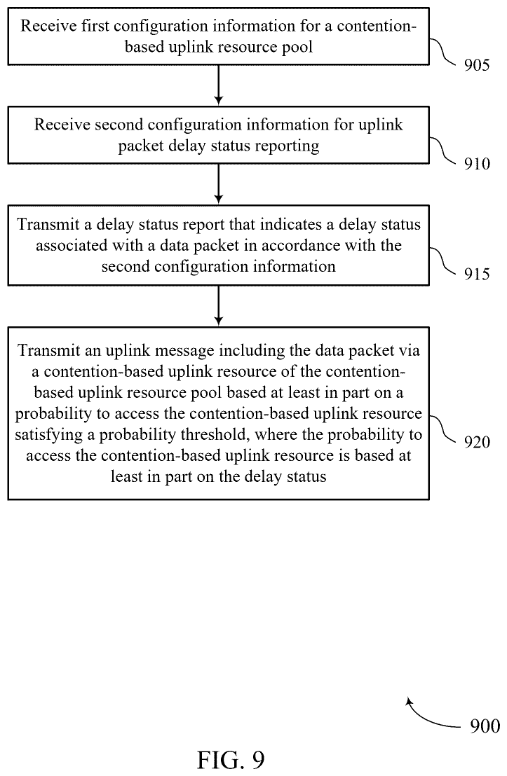

FIG. 9 shows a flowchart illustrating a method 900 that supports delay dependent uplink resource selection in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving first configuration information for a contention-based uplink resource pool. The operations of 905 may be performed in accordance with examples as disclosed herein. In some examples, aspects of the operations of 905 may be performed by a contention-based uplink resource pool 725 as described with reference to FIG. 7.

At 910, the method may include receiving second configuration information for uplink packet delay status reporting. The operations of 910 may be performed in accordance with examples as disclosed herein. In some examples, aspects of the operations of 910 may be performed by a delay status reporting configuration manager 730 as described with reference to FIG. 7.

At 915, the method may include transmitting a delay status report that indicates a delay status associated with a data packet in accordance with the second configuration information. The operations of 915 may be performed in accordance with examples as disclosed herein. In some examples, aspects of the operations of 915 may be performed by a delay status reporting manager 735 as described with reference to FIG. 7.

At 920, the method may include transmitting an uplink message including the data packet via a contention-based uplink resource of the contention-based uplink resource pool based at least in part on a probability to access the contention-based uplink resource satisfying a probability threshold, where the probability to access the contention-based uplink resource is based at least in part on the delay status. The operations of 920 may be performed in accordance with examples as disclosed herein. In some examples, aspects of the operations of 920 may be performed by a contention-based uplink transmission manager 740 as described with reference to FIG. 7.

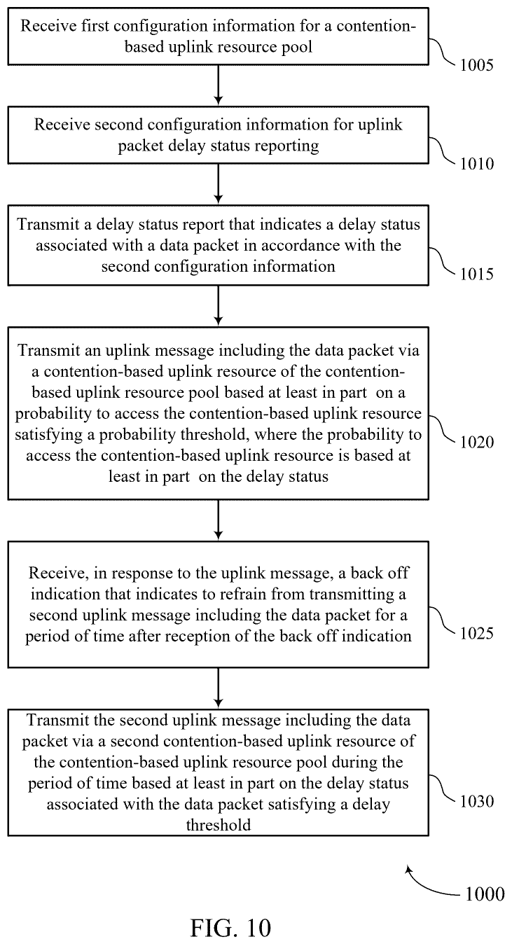

FIG. 10 shows a flowchart illustrating a method 1000 that supports delay dependent uplink resource selection in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving first configuration information for a contention-based uplink resource pool. The operations of 1005 may be performed in accordance with examples as disclosed herein. In some examples, aspects of the operations of 1005 may be performed by a contention-based uplink resource pool 725 as described with reference to FIG. 7.

At 1010, the method may include receiving second configuration information for uplink packet delay status reporting. The operations of 1010 may be performed in accordance with examples as disclosed herein. In some examples, aspects of the operations of 1010 may be performed by a delay status reporting configuration manager 730 as described with reference to FIG. 7.

At 1015, the method may include transmitting a delay status report that indicates a delay status associated with a data packet in accordance with the second configuration information. The operations of 1015 may be performed in accordance with examples as disclosed herein. In some examples, aspects of the operations of 1015 may be performed by a delay status reporting manager 735 as described with reference to FIG. 7.

At 1020, the method may include transmitting an uplink message including the data packet via a contention-based uplink resource of the contention-based uplink resource pool based at least in part on a probability to access the contention-based uplink resource satisfying a probability threshold, where the probability to access the contention-based uplink resource is based at least in part on the delay status. The operations of 1020 may be performed in accordance with examples as disclosed herein. In some examples, aspects of the operations of 1020 may be performed by a contention-based uplink transmission manager 740 as described with reference to FIG. 7.

At 1025, the method may include receiving, in response to the uplink message, a back off indication that indicates to refrain from transmitting a second uplink message including the data packet for a period of time after reception of the back off indication. The operations of 1025 may be performed in accordance with examples as disclosed herein. In some examples, aspects of the operations of 1025 may be performed by a back off indication manager 750 as described with reference to FIG. 7.

At 1030, the method may include transmitting the second uplink message including the data packet via a second contention-based uplink resource of the contention-based uplink resource pool during the period of time based at least in part on the delay status associated with the data packet satisfying a delay threshold. The operations of 1030 may be performed in accordance with examples as disclosed herein. In some examples, aspects of the operations of 1030 may be performed by a contention-based uplink transmission manager 740 as described with reference to FIG. 7.

The following provides an overview of aspects of the present disclosure:

Aspect 1: A method for wireless communications at a UE, comprising: receiving first configuration information for a contention-based uplink resource pool; receiving second configuration information for uplink packet delay status reporting; transmitting a delay status report that indicates a delay status associated with a data packet in accordance with the second configuration information; and transmitting an uplink message comprising the data packet via a contention-based uplink resource of the contention-based uplink resource pool based at least in part on a probability to access the contention-based uplink resource satisfying a probability threshold, wherein the probability to access the contention-based uplink resource is based at least in part on the delay status.

Aspect 2: The method of aspect 1, further comprising: receiving an indication of a configuration associated with calculation of the probability, wherein the configuration comprises an uplink delay-status based function, and wherein the probability is based at least in part on the configuration.

Aspect 3: The method of aspect 2, wherein the configuration further comprises a priority-based function, and the probability is further based at least in part on a priority of the data packet.

Aspect 4: The method of any of aspects 2 through 3, wherein the configuration further comprises a buffer status-based function, and the probability is further based at least in part on an amount of buffered data for uplink transmission at the UE in association with the buffer status-based function, the amount of buffered data comprising the data packet.

Aspect 5: The method of any of aspects 1 through 4, further comprising: receiving, in response to the uplink message, a back off indication that indicates to refrain from transmitting a second uplink message comprising the data packet for a period of time after reception of the back off indication; and transmitting the second uplink message comprising the data packet via a second contention-based uplink resource of the contention-based uplink resource pool during the period of time based at least in part on the delay status associated with the data packet satisfying a delay threshold.

Aspect 6: The method of any of aspects 1 through 5, wherein transmitting the delay status report comprises: transmitting the delay status report based at least in part on an RDB associated with the data packet being below a threshold, wherein the second configuration information comprises the threshold.

Aspect 7: The method of any of aspects 1 through 6, further comprising: receiving, in response to the uplink message, a back off indication that indicates to refrain from transmitting a second uplink message comprising the data packet for a period of time after reception of the back off indication, wherein the period of time is based at least in part on the delay status.

Aspect 8: The method of aspect 7, wherein the period of time is based at least in part on a priority of the data packet.

Aspect 9: The method of any of aspects 7 through 8, further comprising: transmitting a BSR that indicates an amount of buffered data for uplink transmission at the UE, wherein the period of time is based at least in part on the amount of buffered data.

Aspect 10: The method of any of aspects 1 through 4 or 6 through 9, further comprising: receiving, in response to the uplink message, a back off indication that indicates to refrain from transmitting a second uplink message comprising the data packet for a period of time after reception of the back off indication; and transmitting the second uplink message comprising the data packet via a second contention-based uplink resource of the contention-based uplink resource pool after a second period of time after the reception of the back off indication, wherein the second period of time is scaled in accordance with a scaling factor with respect to the period of time based at least in part on the delay status.

Aspect 11: The method of aspect 10, wherein transmission of the second uplink message after the second period of time is based at least in part on transmission of the delay status report.

Aspect 12: The method of any of aspects 10 through 11, further comprising: receiving an indication of a prohibit timer associated with frequency of scaling the period of time; and starting the prohibit timer based at least in part on transmission of the second uplink message.

Aspect 13: The method of any of aspects 10 through 12, further comprising: receiving an indication of at least one of the scaling factor or a scaling factor range that includes the scaling factor.

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, a GPU, and NPU, an ASIC, a CPU, a GPU, an NPU, an ASIC, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first configuration information for a contention-based uplink resource pool;
receive second configuration information for uplink packet delay status reporting;
transmit a delay status report that indicates a delay status associated with a data packet in accordance with the second configuration information; and
transmit an uplink message comprising the data packet via a contention-based uplink resource of the contention-based uplink resource pool based at least in part on a probability to access the contention-based uplink resource satisfying a probability threshold, wherein the probability to access the contention-based uplink resource is based at least in part on the delay status.

2. The UE of claim 1, wherein the one or more processors are individually or collectively further operable to execute the code to cause the UE to:
receive an indication of a configuration associated with calculation of the probability, wherein the configuration comprises an uplink delay-status based function, and wherein the probability is based at least in part on the configuration.

3. The UE of claim 2, wherein:
the configuration further comprises a priority-based function, and
the probability is further based at least in part on a priority of the data packet.

4. The UE of claim 2, wherein:
the configuration further comprises a buffer status-based function, and
the probability is further based at least in part on an amount of buffered data for uplink transmission at the UE in association with the buffer status-based function, the amount of buffered data comprising the data packet.

5. The UE of claim 1, wherein the one or more processors are individually or collectively further operable to execute the code to cause the UE to:
receive, in response to the uplink message, a back off indication that indicates to refrain from transmitting a second uplink message comprising the data packet for a period of time after reception of the back off indication; and
transmit the second uplink message comprising the data packet via a second contention-based uplink resource of the contention-based uplink resource pool during the period of time based at least in part on the delay status associated with the data packet satisfying a delay threshold.

6. The UE of claim 1, wherein, to transmit the delay status report, the one or more processors are individually or collectively operable to execute the code to cause the UE to:
transmit the delay status report based at least in part on a remaining delay budget associated with the data packet being below a threshold, wherein the second configuration information comprises the threshold.

7. The UE of claim 1, wherein the one or more processors are individually or collectively further operable to execute the code to cause the UE to:
receive, in response to the uplink message, a back off indication that indicates to refrain from transmitting a second uplink message comprising the data packet for a period of time after reception of the back off indication, wherein the period of time is based at least in part on the delay status.

8. The UE of claim 7, wherein the period of time is based at least in part on a priority of the data packet.

9. The UE of claim 7, wherein the one or more processors are individually or collectively further operable to execute the code to cause the UE to:
transmit a buffer status report that indicates an amount of buffered data for uplink transmission at the UE, wherein the period of time is based at least in part on the amount of buffered data.

10. The UE of claim 1, wherein the one or more processors are individually or collectively further operable to execute the code to cause the UE to:
receive, in response to the uplink message, a back off indication that indicates to refrain from transmitting a second uplink message comprising the data packet for a period of time after reception of the back off indication; and
transmit the second uplink message comprising the data packet via a second contention-based uplink resource of the contention-based uplink resource pool after a second period of time after the reception of the back off indication, wherein the second period of time is scaled in accordance with a scaling factor with respect to the period of time based at least in part on the delay status.

11. The UE of claim 10, wherein transmission of the second uplink message after the second period of time is based at least in part on transmission of the delay status report.

12. The UE of claim 10, wherein the one or more processors are individually or collectively further operable to execute the code to cause the UE to:
receive an indication of a prohibit timer associated with frequency of scaling the period of time; and
start the prohibit timer based at least in part on transmission of the second uplink message.

13. The UE of claim 10, wherein the one or more processors are individually or collectively further operable to execute the code to cause the UE to:
receive an indication of at least one of the scaling factor or a scaling factor range that includes the scaling factor.

14. A method for wireless communications at a user equipment (UE), comprising:
receiving first configuration information for a contention-based uplink resource pool;
receiving second configuration information for uplink packet delay status reporting;
transmitting a delay status report that indicates a delay status associated with a data packet in accordance with the second configuration information; and
transmitting an uplink message comprising the data packet via a contention-based uplink resource of the contention-based uplink resource pool based at least in part on a probability to access the contention-based uplink resource satisfying a probability threshold, wherein the probability to access the contention-based uplink resource is based at least in part on the delay status.

15. The method of claim 14, further comprising:
receiving an indication of a configuration associated with calculation of the probability, wherein the configuration comprises an uplink delay-status based function, and wherein the probability is based at least in part on the configuration.

16. The method of claim 15, wherein:
the configuration further comprises a priority-based function, and
the probability is further based at least in part on a priority of the data packet.

17. The method of claim 15, wherein:
the configuration further comprises a buffer status-based function, and
the probability is further based at least in part on an amount of buffered data for uplink transmission at the UE in association with the buffer status-based function, the amount of buffered data comprising the data packet.

18. The method of claim 14, further comprising:
receiving, in response to the uplink message, a back off indication that indicates to refrain from transmitting a second uplink message comprising the data packet for a period of time after reception of the back off indication; and
transmitting the second uplink message comprising the data packet via a second contention-based uplink resource of the contention-based uplink resource pool during the period of time based at least in part on the delay status associated with the data packet satisfying a delay threshold.

19. The method of claim 14, wherein transmitting the delay status report comprises:
transmitting the delay status report based at least in part on a remaining delay budget associated with the data packet being below a threshold, wherein the second configuration information comprises the threshold.

20. A non-transitory computer-readable medium storing code for wireless communications, the code comprising instructions executable by one or more processors to:
receive first configuration information for a contention-based uplink resource pool;
receive second configuration information for uplink packet delay status reporting;
transmit a delay status report that indicates a delay status associated with a data packet in accordance with the second configuration information; and
transmit an uplink message comprising the data packet via a contention-based uplink resource of the contention-based uplink resource pool based at least in part on a probability to access the contention-based uplink resource satisfying a probability threshold, wherein the probability to access the contention-based uplink resource is based at least in part on the delay status.
